(19) United States
(12) Patent Application Publication
(10) Pub. No.: US 2013/0330547 A1
(43) Pub. Date: Dec. 12, 2013

(54) ACTIVATING TREATMENT METHOD FOR OPTICAL FILM, METHOD FOR PRODUCING OPTICAL LAMINATED-FILM, OPTICAL LAMINATED-FILM, AND IMAGE DISPLAY DEVICE

(71) Applicant: NITTO DENKO CORPORATION, Osaka (JP)

(72) Inventors: Masashi Shinagawa, Ibaraki-shi (JP); Ryuuichi Inoue, Ibaraki-shi (JP)

(21) Appl. No.: 13/912,613

(22) Filed: Jun. 7, 2013

(30) Foreign Application Priority Data
Jun. 8, 2012 (JP) 2012-130927

(51) Int. Cl. B29D 11/00; G02B 5/30

(52) U.S. Cl. CPC B29D 11/0073; G02B 5/30
USPC 428/354; 156/272.2; 156/272.6; 156/275.7

(57) ABSTRACT

An activating treatment method for an optical film includes feeding the optical film along a roll, and subjecting the optical film to the activating treatment from a side of the optical film that is opposite to a side of the optical film at which the roll is located. The activating treatment is conducted while the roll is cooled.

### BACKGROUND OF THE INVENTION

1. Field of the Invention

The present invention relates to an activating treatment method for an optical film, and a method for producing an optical laminated-film. The present invention also relates to an optical laminated-film obtained by this producing method. The optical film can form, alone or in the form of being laminated onto a different member, into a member of an image display device such as a liquid crystal display device (LCD), an organic EL display device, a CRT or a PDP.

2. Description of the Related Art

Any liquid crystal display device is a device in which a polarization state based on the switching of liquid crystal is made visible. According to a display principle thereof, an optical laminated-film is used which is, for example, a polarizing film obtained by bonding a transparent protective film onto each surface of a polarizer through an adhesive layer. As one of the most popular polarizers, for example, the following is used: an iodine-containing polarizer having a structure yielded by adsorbing iodine into a polyvinyl alcohol film and drawing the film since this polarizer is high in transmittance and polarization degree. The transparent protective film is, for example, a triacetylcellulose film, which is high in moisture permeability.

An adhesive used to form the adhesive layer is, for example, the so-called water-based adhesive in which a polyvinyl alcohol based material is dissolved in water. However, when the water-based adhesive is allowed to stand still in a high-temperature and high-humidity environment over a long period, the adhesive absorbs humidity to be lowered in tackiness. Thus, a peel is easily generated in a (laminated) polarizing film as described above, or the polarizing film is declined in dimension stability to cause a problem of causing a change in the hue of a liquid crystal display device. Against this problem, suggested is an invention of applying saponification treatment to a surface of a triacetylcellulose film used as a transparent protective film to improve the tackiness between the transparent protective film and an adhesive thereon (Patent Document 1). Suggested is also an invention in which an adhesive as described above is an adhesive containing an acetoacetyl-group-containing polyvinyl alcohol based resin and a crosslinking agent (Patent Document 2).

Suggested is also an invention using, instead of any water-based adhesive, a curable adhesive such as a thermosetting adhesive or an active-energy-ray curable adhesive (Patent Document 3). However, even in this case, in which the curable adhesive is used, this adhesive does not give a sufficient tackiness for adhesion between a polarizer and a transparent protective film.

Patent Document 4 describes a method of causing a polarizer and protective films to be brought into close contact with opposite rollers heated to 40° C. and humidified while an adhesive therebetween is cured at the time of being treated with UVs, thereby producing a polarizing film restraining the generation of reversed curling or waved curling. However, in connection with this method, the generation of a contaminant is not anticipated. Moreover, the document neither discloses nor suggests any method of preventing the generation.
[Patent Document 1] JP-A-56-50301
[Patent Document 2] JP-A-7-198945
[Patent Document 3] Japan Patent No. 3511111
[Patent Document 4] JP-A-2009-134190

When two or more optical films are laminated over each other through an adhesive layer, it is important to improve the adhering strength therebetween. When the resultant laminated-optical film is, in particular, a polarizing film, it is desired to make a further improvement in the adhesive strength between its polarizer and its transparent protective film. A method for improving the tackiness between optical films is, for example, an activating treatment such as corona discharge treatment, plasma treatment or glow discharge treatment. However, in accordance with conditions for the treatment, external appearance defects may be caused in the optical films subjected to the activating treatment. In conclusion, although it is indispensable to conduct an activating treatment for improving the tackiness between optical films, external appearance defects are generated to the accompaniment of the treatment so as to bring an actual situation that it is difficult to make an improvement in the tackiness between the optical films consistent with the prevention of the generation of the external appearance defects.

### SUMMARY OF THE INVENTION

An object of the present invention is to provide an activating treatment method for an optical film that makes it possible to make, in a laminated optical film, an improvement of the tackiness between its layers consistent with the prevention of the generation of external appearance defects, and a method for producing the optical laminated-film.

Another object of the present invention is to provide an optical laminated-film obtained by the above-mentioned producing method.

Still another object of the present invention is to provide an image display device, such as a liquid crystal display device, having the optical laminated-film.

In order to solve the problems, the inventors have first made eager investigations about the generation mechanism of external appearance defects generated when an optical film is subjected to an activating treatment.

As a result, the following have been ascertained:

(1) By electric discharge for the activating treatment, high-energy electrons or ions collide with the front surface of the optical film so that radicals or ions are generated in the optical film front surface.

(2) These species react with N₂, O₂, H₂ and/or others around the species to introduce polar reactive groups, such as carboxyl, hydroxyl and/or cyano groups, into the surface. Simultaneously, an oxalic acid salt (ammonium oxalate:(NH₄)₂C₂O₂) and/or other compounds are also generated.

(3) The oxalic acid salt and/or the compounds are deposited on the optical film to cause external appearance defects.

On the basis of these findings, the inventors have further made investigations to make it evident that by subjecting an optical film to an activating treatment while the optical film is cooled, the following can be prevented: the deposit of an oxalic acid salt and/or other compounds that is caused by the above-mentioned facts (1) and (2), and the generation of external appearance defects that is based on the deposit. The present invention has been gained by these findings.

Accordingly, the present invention relates to an activating treatment method for an optical film, including feeding the optical film along a roll, and subjecting the optical film to the activating treatment from a side of the optical film that is opposite to a side of the optical film at which the roll is located, wherein the activating treatment is conducted while the roll is cooled.

In the activating treatment method, it is preferred that the activating treatment is at least one selected from the group consisting of corona discharge treatment, plasma treatment, and glow discharge treatment.

In the activating treatment method, it is preferred that the optical film is at least one selected from the group consisting of a polarizer and a transparent protective film.

In the activating treatment method, it is preferred that in the activating treatment, an electric discharge quantity of 100 to 2000 W·min/m² is discharged.

In the activating treatment method, it is preferred that the roll is cooled by passing a coolant into the roll.

The present invention also relates to a method for producing an optical laminated-film including a first optical film, an adhesive layer and a second optical film in which the second optical film is laminated over at least one surface of the first optical film to interpose the adhesive layer between the optical films,

including an activating treatment step of conducting the activating treatment method recited above onto a surface of the first optical film onto which the adhesive layer is to be laminated, an applying step of applying an adhesive onto the surface of the first optical film onto which the activating treatment is conducted, thereby laminating a layer of the adhesive onto the surface, and a laminating step of bonding the first optical film on which the adhesive layer is laminated over the second optical film through the adhesive layer.

In the method for producing the optical laminated-film, it is preferred that the optical laminated-film is a polarizing film including a polarizer, an adhesive layer and a transparent protective film in which the transparent protective film is laminated over at least one surface of the polarizer to interpose the adhesive layer between the polarizer and the film; and the method including: the activating treatment step which is an activating treatment step of conducting the activating treatment method recited above onto at least one of the polarizer and the transparent protective film; the applying step which is an applying step of applying the adhesive onto the surface of the polarizer that is subjected to the activating treatment or the surface of the transparent protective film that is subjected to the activating treatment, thereby laminating a layer of the adhesive onto the surface; and the laminating step which is a laminating step of bonding the polarizer and the transparent protective film over each other through the adhesive layer.

The present invention further relates to an optical laminated-film obtained by the above-mentioned producing method, and an image forming device, using the optical laminated-film.

In the present invention, at the time of subjecting an optical film to an activating treatment while the optical film is brought into close contact with the outer circumferential surface of a roll, the activating treatment of the optical film is conducted while the roll is cooled. This manner makes it possible to prevent the generation of external appearance defects, which are caused by an oxalic acid salt or other compounds generated and deposited on the optical film.

Generally, in the case of adopting electric discharge treatment as an activating treatment method, the quantity of hydroxyl groups introduced onto an optical film, and other functional groups contributing to an improvement in the tackiness of the film is increased when the electric discharge quantity is raised in the activating treatment. Thus, an improvement is made in the tackiness of the optical film onto another optical film through an adhesive layer. However, as the electric discharge quantity is raised in the activating treatment, the generation amount of an oxalic acid salt or others, which may cause external appearance defects, is also increased. As described above, therefore, it is difficult to make an improvement in the tackiness between the optical films consistent with the prevention of the generation of external appearance defects. However, in the present invention, in the case of subjecting an optical film to an activating treatment to be improved in tackiness, the generation amount of an oxalic acid salt or others can be remarkably reduced even when the electric discharge quantity is raised. The reduction makes it possible to make an improvement in the tackiness of the optical film consistent with the prevention of the generation of external appearance defects.

The activating treatment method according to the present invention for an optical film is useful for an activating treatment conducted when this optical film is, in particular, a polarizer and/or a transparent protective film. Generally, when an optical film is subjected to an activating treatment, the quantity of hydroxyl groups and/or other functional groups that can be introduced onto the optical film becomes smaller as the moisture content in the optical film is made smaller. Accordingly, the degree of an improvement of the film in tackiness becomes smaller. However, when the electric discharge quantity is raised in the activating treatment, the quantity of functional groups introduced onto the optical film is increased. Thus, even when the moisture content in the optical film is low, the optical film is improved in tackiness. Accordingly, the activating treatment method according to the present invention for an optical film is very useful for an activating treatment conducted when the optical film is an optical film low in the moisture content, particularly, when the film is a polarizer and/or a transparent protective film.

In the method for producing an optical laminated-film that has an activating treatment step of conducting the activating treatment method according to the present invention for an optical film, the produced optical laminated-film can be an optical laminated-film in which the tackiness between its laminated optical films is excellent and external appearance defects are remarkably reduced.

Particularly, in the method of producing a polarizing film as the optical laminated-film, the produced polarizing film can be a polarizing film in which the tackiness between its polarizer and its transparent protective film can be enhanced while external appearance defects are remarkably reduced.

### BRIEF DESCRIPTION OF THE DRAWINGS

FIG. 1 is a schematic view illustrating an embodiment of the activating treatment method according to the present invention for an optical film; and

FIG. 2 is a schematic view illustrating another embodiment of the activating treatment method according to the present invention for an optical film.

### DETAILED DESCRIPTION OF THE PREFERRED EMBODIMENTS

In the activating treatment method according to the present invention for an optical film, at the time of conducting an activating treatment of the optical film while the film is brought into close contact with the outer circumferential surface of a roll, the optical film is subjected to the activating treatment while the roll is cooled. The present invention is useful, particularly, as an activating treatment method for an optical film in which the moisture content is low so that the electric discharge quantity needs to be raised when the film is subjected to an activating treatment, specifically, an activating treatment method for, for example, a polarizer or a transparent protective film.

### <Polarizer>

The polarizer is not particularly limited, and may be of various types. The polarizer is, for example, a polarizer obtained by adsorbing a dichroic dye or dichroic substance such as iodine into a hydrophilic polymer film, such as a polyvinyl alcohol film, a partially formylated polyvinyl alcohol film or an ethylene/vinyl acetate copolymer partially saponified film, and then drawing the film monoaxially; or a polyene-aligned film made of, for example, a polyvinyl-alcohol dehydrated product or a polyvinyl-chloride dehydrochloride-treated product. Among such films, preferred is a polarizer composed of a polyvinyl alcohol film and a dichroic substance such as iodine. The thickness of such a polarizer is not particularly limited, and is generally from about 10 to 80 μm. The polarizer having the general thickness has a moisture content of about 10 to 30% within one hour of the time of starting to dry the polarizer. The polarizer thickness is preferably from 10 to 30 μm, most preferably from 15 to 25 μm. The moisture content in the polarizer is preferably from 10 to 25%, most preferably from 15 to 20%.

The moisture content in the polarizer may be controlled by any appropriate method. The method may be, for example, a method of making the control by adjusting conditions for a drying step in a process for producing the polarizer.

The moisture content in the polarizer is measured by the following method: the polarizer is cut into a size of 100×100 mm; the initial weight of this sample is measured; subsequently, the sample is dried at 120° C. for 2 hours, and the dry weight thereof is measured; and the moisture content is calculated in accordance with an expression of “moisture content (% by weight)”={(“initial weight”−“dry weight”)/“initial weight”}×100; provided that these weights are each a value obtained by making the measurement three times and then averaging the resultant values.

The polarizer obtained by dyeing a polyvinyl alcohol film with iodine and then drawing the film monoaxially may be formed, for example, by immersing the polyvinyl alcohol film in an aqueous solution of iodine so as to be dyed, and then drawing the film into a length 3 to 7 times the original length. If necessary, the film may be immersed in an aqueous solution of potassium iodide that may contain, for example, boric acid, zinc sulfate, or zinc chloride. If necessary, before the dyeing, the polyvinyl alcohol film may be further immersed in water to be washed. The washing of the polyvinyl alcohol film with water makes it possible to clean off stains or a blocking inhibitor on surfaces of the polyvinyl alcohol film, and further causes the polyvinyl alcohol film to be swelled, thus producing an advantageous effect of preventing an unevenness in the dyed color or some other unevenness. The drawing may be performed after, while or before the dyeing with iodine is performed. The drawing may be performed in an aqueous solution of boric acid, potassium iodide or some other, or in a water bath.

### <<Thin Polarizer>>

The above-mentioned polarizer may be a thin polarizer that has a thickness of 10 μm or less. From the viewpoint of making a polarizing film having the polarizer thinner, the thickness is preferably from 1 to 7 μm. Such a thin polarizer is preferred since the polarizer is small in thickness unevenness, excellent in perceivability, and small in dimension change to be excellent in endurance, and further makes the polarizing film small in thickness.

The thin polarizer is lower in the moisture content than polarizers having an ordinary thickness. The lower moisture content is from about 0 to 10% within one hour of the time of starting to dry the polarizer. Accordingly, when the thin polarizer is subjected to an activating treatment to improve the tackiness thereof, it is inevitably necessary to raise the electric discharge quantity. Thus, the activating treatment method according to the present invention is useful, particularly, as an activating treatment method for any thin polarizer. The thickness of the thin polarizer is preferably from 1 to 7 μm, most preferably from 2 to 6 μm. The moisture content in the polarizer is preferably from 1 to 5%, most preferably from 1 to 3%.

Typical examples of the thin polarizer include thin polarizers described in publications of JP-A-51-069644 and JP-A-2000-338329, the pamphlet of WO2010-100917, the specification of PCT-JP2010/001460, and thin polarizing films described in specifications of Japanese Patent Applications No. 2010-269002 and No. 2010-263692. These thin polarizing films can be obtained by a producing method including the step of drawing a layer of a polyvinyl alcohol based resin (hereinafter referred to also as a PVA-based resin) and a resin substrate for drawing in the state that these are laminated on each other, and the step of dyeing the laminate. According to this producing method, the PVA-based resin layer can be drawn without causing inconveniences by the drawing, such as breaking, even when the PVA-based resin layer is thin. This is because the PVA-based resin layer is supported by the drawing resin substrate.

The thin polarizing film is preferably a polarizing film obtained by the following method out of methods as described above, which includes the step of drawing a PVA-based resin film laminated on a substrate and the step of dyeing the laminate, since the resin film can be drawn into a high draw ratio and improved in polarizing performance: a method including the step of drawing such a laminate in an aqueous boric acid solution, as described in the pamphlet of WO 2010/10917, or a specification of PCT/JP 2010/001460 or Japanese Patent Application No. 2010-269002 or 2010-263692. The thin polarizing film is in particular preferably a polarizing film obtained by the method described in the specification of Japanese Patent Application No. 2010-269002 or 2010-263692, which includes the step of drawing such a laminate subsidiarily in the air before the laminate is drawn in an aqueous boric acid solution.

The polarizing film described in the specification of PCT/JP 2010/001460 is unified with a resin substrate so as to be produced. The produced film is a thin highly-functional polarizing film having a thickness of 7 μm or less and formed to include a PVA-based resin in which a dichroic material is aligned. The film has following optical properties: a single transmittance of 42.0% or more; and a polarization degree of 99.95% or more.

The thin highly-functional polarizing film can be produced by: applying a PVA-based resin onto a resin substrate having a thickness of at least 20 μm and then drying the resultant workpiece to produce a PVA-based resin layer; immersing the produced PVA-based resin layer in a dyeing liquid of a dichroic material to adsorb the dichroic material into the PVA-based resin layer; and then drawing the dichroic-material-adsorbed PVA-based resin layer unified with the resin substrate in an aqueous boric acid solution to give a total draw ratio of 5 or more, i.e., the total length is 5 times or more of the original length.

The thin highly-functional polarizing film can be produced by a method for producing a laminate film containing a thin highly-functional polarizing film in which a dichroic material is aligned, specifically, a method including: the step of producing a laminated film including a resin substrate having a thickness of at least 20 μm, and a PVA-based resin layer formed by applying an aqueous solution containing a PVA-based resin onto a single surface of the resin substrate and then drying the workpiece; the step of immersing this laminated film in a dyeing liquid containing a dichroic material to adsorb the dichroic material into the PVA-based resin layer contained in the laminated film; and the step of drawing the resultant laminated film in an aqueous boric acid solution to give a total draw ratio of 5 or more, i.e., the total length 5 times or more of the original length so as to form, through the drawing of the dichroic-material-adsorbed PVA-based resin layer unified with the resin substrate, a laminated film in which the following polarizing film is formed (as the target thin highly-functional polarizing film): a thin highly-functional polarizing film composed of the resin substrate, and the dichroic-material-aligned PVA-based resin layer on the single surface of the resin substrate, and formed to have a thickness of 7 μm or less and optical properties that the single transmittance is 42.0% or more and the polarization degree is 99.95% or more.

In the present invention, the above-mentioned thin polarizer, which has a thickness of 10 μm or less, may be a continuously-web-form polarizing film that is made of a PVA-based resin in which a dichroic material is aligned, and that is obtained through a two-stage drawing step of drawing, subsidiarity in the air, a laminate composed of a thermoplastic resin substrate and a PVA-based resin layer formed on the substrate, and then drawing the laminate in an aqueous boric acid solution. The thermoplastic resin substrate is preferably an amorphous ester thermoplastic resin substrate or crystalline ester thermoplastic resin substrate.

The thin polarizing film described in the specification of Japanese Patent Application No. 2010-269002 or 2010-263692 is a continuously-web-form polarizing film made of a PVA-based resin in which a dichroic material is aligned, and is also a film the thickness of which is set to 10 μm or less by drawing a laminate containing a PVA-based resin layer formed on an amorphous ester thermoplastic resin substrate through a two-stage drawing step of subsidiary drawing in the air and drawing in an aqueous boric acid solution. This thin polarizing film is a film formed to have optical properties satisfying the following: P>−(10^{0.929T-42.4}−1)×100 wherein T<42.3, and P≧99.9 wherein T≧42.3 when the single transmittance of the film is represented by T and the polarization degree thereof is represented by P.

Specifically, this thin polarizing film can be produced by a thin-polarizing-film producing method including the step of drawing, at high temperature in the air, a PVA-based resin layer formed on an amorphous ester thermoplastic resin substrate in a continuous web form to produce a drawn intermediate product made of the PVA-based resin layer aligned, the step of adsorbing a dichroic material (preferably, iodine or a mixture of iodine and an organic dye) into the dawn intermediate product to produce a colored intermediate product made of the PVA-based resin layer in which the dichroic material is aligned, and the step of drawing the colored intermediate product in an aqueous boric acid solution to produce a polarizing film made of the PVA-based resin layer in which the dichroic material is aligned and having a thickness of 10 μm or less.

In this producing method, it is desired to adjust, into 5 or more, the total draw ratio of the PVA-based resin layer formed on the amorphous ester thermoplastic resin substrate by the high-temperature drawing in the air and the drawing in the aqueous boric acid solution. The liquid temperature of the aqueous boric acid solution for the drawing in this solution may be set to 60° C. or higher. Before the drawing of the colored intermediate product in the aqueous boric acid solution, this product is desirably subjected to insoluble treatment. In this case, it is desired to conduct the treatment by immersing the colored intermediate product into the aqueous boric acid solution having a liquid temperature lower than 40° C. The amorphous ester thermoplastic resin substrate may be made of an isophthalic-acid-copolymerized polyethylene terephthalate copolymer, a cyclohexanedimethanol-copolymerized polyethylene terephthalate copolymer, or an amorphous polyethylene terephthalate containing a different polyethylene terephthalate copolymer, and is preferably made of a transparent resin. The thickness thereof may be made at least 7 times larger than the thickness of the formed PVA-based resin layer. The draw ratio in the high-temperature drawing in the air is preferably 3.5 or less. The drawing temperature for the high-temperature drawing in the air is preferably the glass transition temperature of the PVA-based resin or higher, and specifically ranges from 95 to 150° C. When the high-temperature drawing in the air is conducted in a free-end monoaxial drawing manner, the total draw ratio of the PVA-based resin formed on the amorphous ester thermoplastic resin substrate is preferably from 5 to 7.5 both inclusive. When the high-temperature drawing in the air is conducted in a fixed-end monoaxial drawing manner, the total draw ratio thereof is preferably from 5 to 8.5 both inclusive.

More specifically, the thin polarizing film can be produced by a method as described in the following:

A substrate in a continuous web form is produced which is made of an isophthalic-acid-copolymerized polyethylene terephthalate (amorphous PET) in which the proportion of copolymerized isophthalic acid is 6% by mole. The glass transition temperature of the amorphous PET is 75° C. A laminate composed of the continuous-web-form amorphous PET substrate and a polyvinyl alcohol (PVA) layer is formed as described below. For reference, the glass transition temperature of PVA is 80° C.

Prepared are the amorphous PET substrate, which has a thickness of 200 μm, and an aqueous PVA solution in which PVA powder having a copolymerization degree of 1000 or more and a saponification degree of 99% or more, is dissolved in water to give a concentration of 4 to 5%. Next, the aqueous PVA solution is applied onto the 200 μm thick amorphous PET substrate, and the workpiece is dried at a temperature of 50 to 60° C. to yield a laminate in which a 7 μm thick PVA layer is formed on the amorphous PET substrate.

The laminate containing the 7 μm thick PVA layer is caused to undergo a two-stage drawing step detailed below, which includes subsidiary drawing in the air and drawing in an aqueous boric acid solution, to produce a thin highly-functional polarizing film of 3 μm thickness. Through the step of the subsidiary drawing in the air at the first stage, the laminate containing the 7 μm thick PVA layer and unified with the amorphous PET substrate is drawn to produce a drawn laminate containing a 5 μm thick PVA layer. Specifically, this drawn laminate is a laminate yielded by setting the laminate containing the 7 μm thick PVA layer to a drawing machine located in an oven, the drawing environment temperature of which is set to 130° C., and then drawing the laminate in a free-end monoaxial drawing manner to give a total draw ratio of 1.8. By this drawing treatment, the PVA layer contained in the drawn laminate is changed to a 5 μm thick PVA layer in which PVA molecules are aligned.

Next, through a dyeing step, iodine is adsorbed into the 5 μm thick PVA layer, in which the PVA molecules are aligned, to produce an iodine-adsorbed colored laminate. Specifically, this colored laminate is a laminate yielded by immersing the drawn laminate in a dyeing liquid having a liquid temperature of 30° C. and containing iodine and potassium iodide for an arbitrary period in such a manner that a PVA layer of a finally-produced highly-functional polarizing film will have a single transmittance of 40 to 44%, thereby adsorbing iodine into the PVA layer contained in the drawn laminate. In the present step, the dyeing liquid contains water as a solvent. The concentration of iodine therein is set in the range of 0.12 to 0.30% by weight, and that of potassium iodide therein in the range of 0.7 to 2.1% by weight. The ratio by concentration of iodide to potassium iodide is 1 to 7. For reference, for the dissolution of iodide into water, potassium iodide is necessary. In more detail, by immersing the drawn laminate into a dyeing liquid containing iodide in a concentration of 0.30% by weight and potassium iodide in a concentration of 2.1% by weight for 60 seconds, a colored laminate is produced in which iodide is adsorbed in the PVA-molecule-aligned 5 μm thick PVA layer.

Furthermore, through the step of the drawing in the aqueous boric acid solution at the second stage, the colored laminate unified with the amorphous PET substrate is further drawn to produce an optical film laminate containing the PVA layer constituting a 3 μm thick highly-functional polarizing film. Specifically, this optical film laminate is a laminate obtained as follows: the colored laminate is set into a drawing machine located in a treatment system which holds an aqueous boric acid solution containing boric acid and potassium iodide and having a liquid temperature ranging from 60 to 85° C., and then the colored laminate is drawn in a free-end monoaxial drawing manner to give a draw ratio of 3.3. In more detail, the liquid temperature of the aqueous boric acid solution is 65° C. In the solution, the boric acid content is set to 4 parts by weight for 100 parts by weight of water, and the potassium iodide content is set to 5 parts by weight therefor. In the present step, the colored laminate, the iodide-adsorbed-amount of which has been adjusted, is first immersed in an aqueous boric acid solution for 5 to 10 seconds. Thereafter, the colored laminate is fed as it is, and passed through plural roll pairs having different peripheral velocities, which constitute the drawing machine located in the treatment system. In this way, the laminate is drawn in a free-end monoaxial drawing manner over 30 to 90 seconds to give a draw ratio of 3.3. By this drawing treatment, the PVA layer contained in the colored laminate is changed into a 3 μm thick PVA layer in which adsorbed iodine is aligned, in the form of a polyiodine ion complex, to a high degree in one direction. This PVA layer constitutes the highly-functional polarizing film which an optical film laminate (or laminated optical film) has.

A washing step, which is an inessential step for the production of the optical film laminate, is preferably conducted. This step is a step of taking out the optical film laminate from the aqueous boric acid solution and then wash, with an aqueous solution of potassium iodide, boric acid adhering to the front surface of the 3 μm thick PVA layer formed on the amorphous PET substrate. Thereafter, the washed optical film laminate is dried in a drying step of attaining drying with hot wind of 60° C. temperature. The washing step is a step for overcoming an external appearance defect based on the precipitation of boric acid and others.

A bonding step and/or a transferring step, which is/are equivalently inessential for the production of the optical film laminate, may be conducted. In the step(s), while an adhesive is applied onto the front surface of the 3 μm thick PVA layer formed on the amorphous PET substrate, a 80 μm thick triacetylcellulose film is bonded onto the surface, and subsequently the amorphous PET substrate is peeled off to permit the 3 μm thick PVA layer to be transferred onto the 80 μm thick triacetylcellulose film.

### [Other Steps]

The method for producing the thin polarizing film may include, besides the above-mentioned steps, other steps. Examples of the other steps include an insoluble treatment step, a crosslinking step, and a drying (moisture-content-adjusting) step. The other steps may each be conducted at any appropriate timing.

Typically, the insoluble treatment step is conducted by immersing the PVA-based resin layer into an aqueous boric acid solution. By conducting the insoluble treatment, water resistance can be given to the PVA-based resin layer. The boric acid concentration in the aqueous boric acid solution is preferably from 1 to 4 parts by weight for 100 parts by weight of water. The liquid temperature of the insoluble treatment bath (aqueous boric acid solution) is preferably from 20 to 50° C. Preferably, the insoluble treatment step is conducted after the production of the laminate and before the dyeing step and the drawing step in the aqueous solution.

Typically, the crosslinking step is conducted by immersing the PVA-based resin layer in an aqueous boric acid solution. By conducting the crosslinking treatment, water resistance can be given to the PVA-based resin layer. The boric acid concentration in the aqueous boric acid solution is preferably from 1 to 4 parts by weight for 100 parts by weight of water. When the crosslinking step is conducted after the dyeing step, it is preferred to blend an iodide into the PVA-based resin layer. By the blending of the iodide, the elution-out of iodide adsorbed in the PVA-based resin layer can be restrained. The blend amount of the iodide is preferably from 1 to 5 parts by weight for 100 parts by weight of water. Specific examples of the iodide are as described above. The liquid temperature of the crosslinking bath (aqueous boric acid solution) is preferably from 20 to 50° C. Preferably, the crosslinking step is conducted before the second-stage drawing step in the aqueous boric acid solution. In a preferred embodiment, the dyeing step, the crosslinking step, and the second-stage drawing step in the aqueous boric acid solution are conducted in this order.

### <Transparent Protective Film>

The material of the transparent protective film (which may be used in the optical film producing method of the present invention) is not particularly limited, and is preferably a material excellent in transparency, mechanical strengths, thermal stability, water blocking performance, isotropy, and others. Examples thereof include polyester polymers such as polyethylene terephthalate, and polyethylene naphthalate; cellulose polymers such as diacetylcellulose and triacetylcellulose; acrylic polymers such as polymethyl methacrylate; styrene polymers such as polystyrene and acrylonitrile/styrene copolymer (AS resin); and polycarbonate polymers. Other examples thereof include polyolefin polymers such as polyethylene, polypropylene, any polyolefin having a cyclic structure or a norbornene structure, and ethylene/propylene copolymer; vinyl chloride based polymers; amide polymers such as nylon and aromatic polyamide; imide polymers; sulfone polymers; polyethersulfone polymers; polyetheretherketone polymers; polyphenylenesulfide polymers; vinyl alcohol based polymers; vinylidene chloride based polymers; vinyl butyral based polymers; acrylate polymers; polyoxymethylene polymers; epoxy polymers; and any blend of two or more of these polymers. The transparent protective film may contain one or more arbitrary appropriate additives. Examples of the additives include an ultraviolet absorbent, an antioxidant, a lubricant, a plasticizer, a release agent, a coloring inhibitor, a frame retardant, a nucleating agent, an antistatic agent, a pigment and a colorant. The content of one or more of the above-mentioned thermoplastic resins in the transparent protective film is preferably from 50 to 100% by mass, more preferably from 50 to 99% by mass, even more preferably from 60 to 98% by mass, particularly preferably from 70 to 97% by mass. If the content of the thermoplastic resin(s) in the transparent protective film is 50% or less by mass, it is feared that a high transparency and other advantages that the thermoplastic resin(s) originally has/have are not sufficiently exhibited.

The moisture content in any ordinary transparent protective film is from about 0 to 7%. The activating treatment method according to the present invention is particularly useful as an activating treatment method for a transparent protective film having a low moisture content, specifically, a transparent protective film having a moisture content of 0 to 1%.

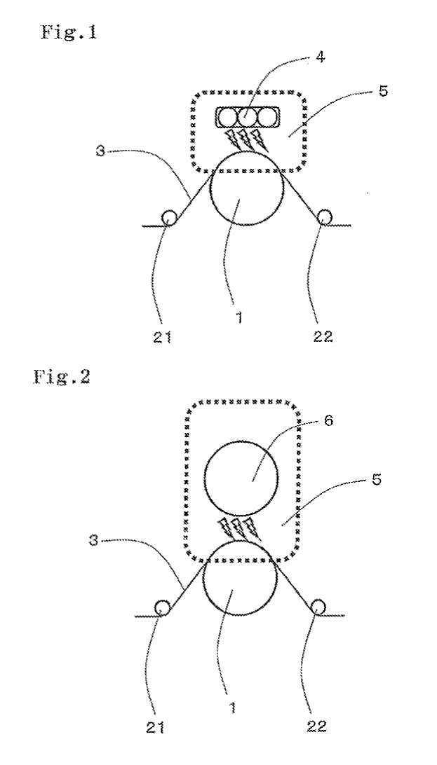

Hereinafter, a description will be made about the activating treatment method according to the present invention for an optical film with reference to the drawings. FIG. 1 is a schematic view illustrating an embodiment of the activating treatment method according to the present invention for an optical film. In the embodiment illustrated in FIG. 1, while an optical film 3 is fed along a roll 1 arranged between two guide rolls 21 and 22, the optical film 3 is subjected to an activating treatment from a side of the optical film 3 that is opposite to a side of the optical film 3 at which the roll 1 is located. At this time, the optical film 1 is subjected to the activating treatment while the roll 1 is cooled.

The method for cooling the roll 1 is, for example, a method of passing a coolant such as water into the roll 1 while the coolant is circulated. The coolant may be any coolant known in those skilled in the art besides water. It is general that at the time of conducting an activating treatment, heat is generated in the front surface of the roll 1 with the radiation of electric discharge to the surface. Thus, the surface temperature is raised to about 80 to 100° C. In the present invention, the roll 1 is cooled to set the surface temperature preferably to 80° C. or lower, more preferably to 50° C. or lower, even more preferably to 30° C. or lower. When the surface temperature of the roll 1 is lowered, the optical film 3 is fed along the outer circumferential surface of the roll 1 while brought into close contact with this outer circumferential surface. Thus, the temperature of the optical film 3 becomes substantially equal to the surface temperature of the roll 1. In other words, by cooling the roll 1, the temperature of the optical film 3 is also cooled to prevent the generation of external appearance defects in the optical film 3. When water is passed as the coolant, the temperature of the water is not particularly limited. The temperature is, for example, from about 20 to 30° C.

Examples of the activating treatment include corona discharge treatment, plasma treatment, glow discharge treatment, ozone treatment, and ITRO treatment. In the case of corona discharge treatment, the roll 1 in FIG. 1 acts as a dielectric (earth) roll, and the corona discharge treatment is conducted through a treatment electrode 4. In FIG. 1, a region surrounded by a frame of a dot line represents an external atmosphere 5 at a place where the activating treatment is conducted (the same as in FIG. 2). Among various corona discharge treatment species, atmospheric pressure corona discharge treatment is preferred wherein the external atmosphere 5 is the atmosphere of the atmospheric air. In the case of plasma treatment, the roll 1 in FIG. 1 acts as a dielectric (earth) roll, and the plasma treatment is conducted through the treatment electrode 4. Among various plasma treatment species, atmospheric pressure plasma treatment is preferred wherein the external atmosphere 5 is the atmosphere of the atmospheric air (including N₂, O₂, Ar and others). In the case of glow discharge treatment, the roll 1 in FIG. 1 acts as a dielectric (earth) roll, and the glow discharge treatment is conducted through the treatment electrode 4 in the state that the external atmosphere 5 is a vacuum.

In the case of ITRO treatment, the roll 1 in FIG. 1 acts as a feeding roll. In the external atmosphere 5 which is the atmosphere of the atmospheric air, the ITRO treatment is conducted from a flame source instead of the treatment electrode 4. In the case of ozone treatment, the roll 1 in FIG. 1 acts as a feeding roll. In the external atmosphere 5 which is the atmosphere of the atmospheric air, the ozone treatment is conducted from an ozone source instead of the treatment electrode 4.

Among these activating treatments, preferred is/are corona discharge treatment, plasma treatment and/or glow discharge treatment, which make(s) an improvement with a good balance in the effect of heightening the tackiness of a matter to be treated, and the effect of preventing the generation of external appearance defects. When corona discharge treatment, plasma treatment and/or glow discharge treatment is/are adopted, the electric discharge quantity is preferably made high to improve the tackiness. Specifically, the electric discharge quantity is set preferably to 100 W·min/m² or more, more preferably to 400 W·min/m² or more, even more preferably to 1000 W·min/m² or more. In order to prevent the generation of external appearance defects in the optical film 3 effectively, the electric discharge quantity in the activating treatment is set preferably to 2000 W·min/m² or less, more preferably to 1500 W·min/m² or less, even more preferably to 1250 W·min/m² or less. Among corona discharge treatment, plasma treatment and glow discharge treatment, preferred are corona discharge treatment and plasma treatment from the viewpoint of the treating capacity, and the design of facilities therefor. More preferred are atmospheric pressure corona discharge treatment and atmospheric pressure plasma treatment, which can be conducted under the atmospheric pressure.

FIG. 1 has illustrated an embodiment in which the treatment electrode 4 is used to conduct the activating treatment. However, as illustrated in FIG. 2, an activating treatment may be conducted by electric discharge radiated from an electrode roll 6 opposite to a roll 1.

The method according to the present invention for producing an optical laminated-film including a first optical film, an adhesive layer and a second optical film in which the second optical film is laminated over at least one surface of the first optical film to interpose the adhesive layer between the optical films. The method includes an activating treatment step of conducting the activating treatment method of the present invention recited in claim 1 onto a surface of the first optical film onto which the adhesive layer is to be laminated, an applying step of applying an adhesive onto the surface of the first optical film onto which the activating treatment is conducted, thereby laminating a layer of the adhesive onto the surface, and a laminating step of bonding the first optical film on which the adhesive layer is laminated over the second optical film through the adhesive layer. The first and second optical films are each preferably a polarizer or a transparent protective film. The present invention is particularly useful as a method for producing an optical laminated-film (polarizing film) wherein: the optical laminated-film is a polarizing film including a polarizer, an adhesive layer and a transparent protective film in which the transparent protective film is laminated over at least one surface of the polarizer to interpose the adhesive layer between the polarizer and the film, this method including: an activating treatment step of conducting the activating treatment method onto at least one of the polarizer and the transparent protective film; an applying step of applying the adhesive onto the surface of the polarizer that is subjected to the activating treatment or the surface of the transparent protective film that is subjected to the activating treatment, thereby laminating a layer of the adhesive onto the surface; and a laminating step of bonding the polarizer and the transparent protective film over each other through the adhesive layer.

In the applying step of applying the adhesive, a manner for the applying may be appropriately selected in accordance with the viscosity of the adhesive and a target thickness thereof. Examples thereof include reverse coating, gravure coating (direct, reverse or offset coating), bar reverse coating, roll coating, die coating, bar coating, and rod coating. A dipping or any other applying manner may be appropriately used.

Through the applied adhesive, optical films, in particular, a polarizer and a transparent protective film are bonded to each other. The bonding may be attained by means of a roll laminator or some other.

After the bonding step, a layer of the adhesive is formed. The formation of the adhesive layer is performed in accordance with the kind of the adhesive. In the present invention, the adhesive is, particularly, an active-energy-ray curable adhesive. The active-energy-ray curable adhesive is an adhesive curable by one or more active energy rays or beams, such as an electron beam or ultraviolet rays. The adhesive is usable, for example, in an electron beam curable or ultraviolet curable form. The active-energy-ray curable adhesive is, for example, of an optical cation polymerization type or an optical radical polymerization type. Of these two types, the former optical cation polymerization type is preferably usable in the present invention. When the optical-radical polymerization-type active-energy-ray curable adhesive is used as an ultraviolet curable adhesive, this adhesive contains a radical polymerizable compound (A) and an optical radical generator (B).

### <<Radical Polymerizable Compound (A)>>

As the radical polymerizable compound (A), a compound having a group containing at least one carbon-carbon double bond, such as a vinyl or (meth)acryloyl group, is usable without any special limitation. Among various radical polymerizable compounds (A), an N-substituted amide monomer represented by the following general formula (I) is preferred in the present invention:

CH₂═C(R¹)—CONH₂₋ₘ—(X—O—R²)ₘ (1)

wherein R¹ represents a hydrogen atom or a methyl group; X(s) (each) represent(s) —CH₂— or —CH₂—CH₂— group(s); R²(s) (each) represent(s) —(CH₂)ₙ—H group(s) wherein n is 0, 1 or 2; and m represents 1, or 2.

Specific examples of the N-substituted amide monomer represented by the general formula (1) include N-hydroxyethyl(meth)acrylamide, N-methylol(meth)acrylamide, N-methoxymethyl(meth)acrylamide, N-ethoxymethyl(meth)acrylamide, N-methoxyethyl(meth)acrylamide, and N-ethoxyethyl(meth)acrylamide. These N-substituted amide monomers may be used alone or in combination of two or more thereof.

The N-substituted amide monomer represented by the general formula (1) can also be preferably a commercially available product. Specific examples thereof include N-hydroxyethylacrylamide (trade name: “HEAA”, manufactured by KOHJIN Holdings Co., Ltd.), N-methoxymethylacrylamide (trade name: “NMMA”, manufactured by MRC UNITEC Co., Ltd.), N-butoxymethylacrylamide (trade name: “NBMA”, manufactured by MRC UNITEC Co., Ltd.), and N-methoxymethylacrylamide (trade name: “WASMER 2MA”, manufactured by Kasano Kosan Co., Ltd.).

The N-substituted amide monomer represented by the general formula (1) is preferably N-hydroxyethyl(meth)acrylamide. Any N-substituted amide monomer exhibits a good tackiness onto a polarizer having a low moisture content, or a transparent protective film made of a material low in moisture permeability. Among the above-mentioned examples of the monomer, N-hydroxyethyl(meth)acrylamide exhibits a particularly good tackiness.

The active-energy-ray curable adhesive may contain, as the radical polymerizable compound (A), for example, an N-substituted amide monomer other than the monomer represented by the general formula (1), a monofunctional (meth)acrylate having an aromatic ring that may be of various types and a hydroxyl group, a urethane (meth)acrylate, a polyester (meth)acrylate, or a compound having a (meth)acryloyl group that may be of various types. When the tackiness and the water resistance of the adhesive layer are considered, the proportion by mass of the N-substituted amide monomer represented by the general formula (1) in the whole of the radical polymerizable compound(s) (A) to be used is preferably from 50 to 99% by mass, more preferably from 60 to 90% by mass.

Examples of the N-substituted amide monomer other than the monomer represented by the general formula (1) include N-methyl(meta)acrylamide, N,N-dimethyl(meta)acrylamide, N,N-diethyl(meta)acrylamide, N-isopropylacrylamide, N-butyl(meta)acrylamide, N-hexyl(meta)acrylamide, aminomethyl(meta)acrylamide, aminoethyl(meta)acrylamide, mercaptomethyl(meta)acrylamide, mercaptoethyl(meta)acrylamide, N-acryoylmorpholine, N-acryloylpiperidine, N-methacryloylpiperidine, and N-acryloylpyrrolidine.

As the monofunctional (meth)acrylate having an aromatic ring and a hydroxyl group, various monofunctional (meth)acrylates each having an aromatic ring and a hydroxyl group are usable. The hydroxyl group may be present as a substituent of the aromatic ring. In the present invention, however, the hydroxyl group is preferably present as a group bonded to an organic group (a hydrocarbon group, particularly, an alkylene group) through which the aromatic ring and the (meth)acrylate are bonded to each other.

The monofunctional (meth)acrylate having an aromatic ring and a hydroxyl group is, for example, a reaction product made from a monofunctional epoxy compound having the same aromatic ring and (meth)acrylic acid. Examples of the monofunctional epoxy compound having an aromatic ring include phenyl glycidyl ether, t-butylphenyl glycidyl ether, and phenylpolyethylene glycol glycidyl ether. Specific examples of the monofunctional (meth)acrylate having an aromatic ring and a hydroxyl group include 2-hydroxyl-3-phenoxypropyl(meth)acrylate, 2-hydroxy-3-t-butylphenoxypropyl(meth)acrylate, and 2-hydroxy-3-phenylpolyethylene glycol propyl(meth)acrylate.

The urethane (meth)acrylate may be, for example, a reaction product made from a (meth)acrylate having an isocyanate group, and a hydroxyl group at a single terminal of a diol compound, such as a polyurethane diol, a polyester diol, a polyether diol, or a polyalkylene glycol such as polyethylene glycol or polypropylene glycol.

Examples of the compound having a (meth)acryloyl group include alkyl(meth)acrylates having 1 to 12 carbon atoms, such as methyl(meth)acrylate, ethyl(meth)acrylate, n-butyl(meth)acrylate, 2-ethylhexyl(meth)acrylate, isooctyl(meth)acrylate, isononyl(meth)acrylate, and lauryl(meth)acrylate; alkoxyalkyl(meth)acrylate monomers, such as methoxyethyl(meth)acrylate, and ethoxyethyl(meth)acrylate; hydroxyl-group-containing monomers, such as 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, and (4-hydroxymethylcyclohexyl)-methyl(meth)acrylate; acid-anhydride-group-containing monomers, such as maleic anhydride, and itaconic anhydride; a caprolactone adduct of acrylic acid; sulfonic-acid-group-containing monomers, such as styrenesulfonic acid, allylsulfonic acid, 2-(meth)acrylamide-2-methylpropanesulfonic acid, (meth)acrylamide propanesulfonic acid, sulfopropyl(meth)acrylate, and (meth)acryloyloxynaphthalenesulfonic acid; and phosphoric-acid-group-containing monomers, such as 2-hydroxyethylacryloyl phosphate. Other examples thereof include (meth)acrylamide; maleimide, N-cyclohexylmaleimide, and N-phenylmaleimide; alkylaminoalkyl(meth)acrylate monomers, such as aminoethyl(meth)acrylate, aminopropyl(meth)acrylate, N,N-dimethylaminoethyl(meth)acrylate, t-butylaminoethyl(meth)acrylate, and 3-(3-pyrinidil)propyl(meth)acrylate; and nitrogen containing monomers including succinimide monomers, such as N-(meth)acryloyloxymethylene succinimide, N-(meth)acryloyl-6-oxyhexamethylene succinimide, and N-(meth)acryloyl-8-oxyoctamethylene succinimide.

Since the water resistance of the adhesive layer is improved, it is preferred that the active-energy-ray curable adhesive further contains, as the radical polymerizable compound (A), a monomer having two or more carbon-carbon double bonds, particularly, a polyfunctional (meth)acrylate monomer having the same. When the water resistance of the adhesive layer is considered, the monomer having two or more carbon-carbon double bond is more preferably hydrophobic. Examples of the hydrophobic monomer having two or more carbon-carbon double bond, particularly, the hydrophobic polyfunctional (meth)acrylate monomer having the same include tricyclodecanedimethanol diacrylate, divinylbenzene, N,N′-methylenebisacrylamide, ethylene glycol di(meth)acrylate, diethylene glycol di(meth)acrylate, triethylene glycol di(meth)acrylate, polyethylene glycol di(meth)acrylate, propylene glycol di(meth)acrylate, dipropylene glycol di(meth)acrylate, tripropylene glycol di(meth)acrylate, polypropylene glycol di(meth)acrylate, 1,4-butanediol di(meth)acrylate, neopentyl glycol di(meth)acrylate, 1,6-hexanediol di(meth)acrylate, 1,9-nonanediol glycol di(meth)acrylate, glycerin, di(meth)acrylate, EO-modified glycerin tri(meth)acrylate, EO-modified diglycerin tetra(meth)acrylate, 2-(2-vinyloxyethoxy)ethyl(meth)acrylate, EO-added bisphenol A/di(meth)acrylate, trimethylolpropane tri(meth)acrylate, a hydroxyl pivalic acid neopentyl glycol(meth)acrylic acid adduct, EO-modified trimethylolpropane tri(meth)acrylate, pentaerythritol tri(meth)acrylate, pentaerythritol tetra(meth)acrylate, dipentaerythritol hexa(meth)acrylate, isocyanuric acid EO modified di(meth)acrylate, isocyanuric acid EO modified tri(meth)acrylate, ∈-caprolactone-modified tris((meth)acryloxyethyl)isocyanurate, 1,1-bis((meth)acryloyloxymethyl)ethyl isocyanate, a polymer made from 2-hydroxyethyl(meth)acrylate and 1,6-diisocyanatehexane, and 9,9-bis[4-(2-(meth)acryloyloxyethoxy)phenyl]fluorene.

The proportion by mass of the monomer having two or more carbon-carbon double bonds in the whole of the radical polymerizable compound(s) (A) to be used is preferably from 5 to 50% by mass, more preferably from 9 to 40% by mass. If this proportion is less than 5% by mass, the adhesive layer may not gain a sufficient water resistance. If the proportion is more than 50% by mass, the adhesive layer may not gain a sufficient tackiness.

### <<Optical Radical Generator (B)>>

The optical radical generator (B) generates radicals by receiving the radiation of an active energy ray or beam. Examples of the optical radical generator (B) include a hydrogen-drawing-type optical radical generator and a cleaving-type optical radical generator.

Examples of the hydrogen-drawing-type optical radical generator include naphthalene derivatives such as 1-methylnaphthalene, 2-methylnaphthalene, 1-fluoronaphthalene, 1-chloronaphthalene, 2-chloronaphthalene, 1-bromonaphthalene, 2-bromonaphthalene, 1-iodonaphthalene, 2-iodonaphthalene, 1-naphthol, 2-naphthol, 1-methoxynaphthalene, 2-methoxynaphthalene, and 1,4-dicyanonaphthalene; anthracene, and anthracene derivatives such as 1,2-benzanthracene, 9,10-dichloroanthracene, 9,10-dibromoanthracene, 9,10-diphenylanthracene, 9-cyanoanthracene, 9,10-dicyanoanthracene, and 2,6,9,10-tetracyanoanthracene; pyrene derivatives; carbazole, and carbazole derivatives such as 9-methylcarbazole, 9-phenylcarbazole, 9-prop-2-yl-9H-carbazole, 9-propyl-9H-carbazole, 9-vinylcarbazole, 9H-carbazole-9-ethanol, 9-methyl-3-nitro-9H-carbazol, 9-methyl-3,6-dinitro-9H-carbazole, 9-octanoylcarbazole, 9-carbazolemethanol, 9-carbazolepropionic acid, 9-carbazolepropionitrile, 9-ethyl-3,6-dinitro-9H-carbazole, 9-ethyl-3-nitrocarbazole, 9-ethylcarbazole, 9-isopropylcarbazole, 9-(ethoxycarbonylmethyl)carbazole, 9-(morpholinomethyl)carbazole, 9-acetylcarbazole, 9-allylcarbazole, 9-benzyl-9H-carbazole, 9-carbazoleacetic acid, 9-(2-nitrophenyl)carbazole, 9-(4-methoxyphenyl)carbazole, 9-(1-ethoxy-2-methyl-propyl)-9H-carbazole, 3-nitrocarbazole, 4-hydroxycarbazole, 3,6-dinitro-9H-carbazole, 3,6-diphenyl-9H-carbazole, 2-hydroxycarbazole, and 3,6-diacetyl-9-ethylcarbazole; benzophenone, and benzophenone derivatives such as 4-phenylbenzophenone, 4,4′-bis(dimethoxy)benzophenone, 4,4′-bis(dimethylamino)benzophenone, 4,4′-bis(diethylamino)benzophenone, 2-benzoylbenzoic acid methyl ester, 2-methylbenzophenone, 3-methylbenzophenone, 4-methylbenzophenone, 3,3′-dimethyl-4-methoxybenzophenone, and 2,4,6-trimethylbenzophenone; aromatic carbonyl compounds; [4-(4-methylphenylthio)phenyl]-phenylmethanone; xanthone; thioxanthone, and thioxanthone derivatives such as 2-chlorothioxanthone, 4-chlorothioxanthone, 2-isopropylthioxanthone, 4-isopropylthioxanthone, 2,4-dimethylthioxanthone, 2,4-diethylthioxanthone, and 1-chloro-4-propoxythioxanthone; and coumarin derivatives.

The cleaving-type optical radical generator is an optical radical generator which is cleaved by receiving the radiation of an active energy ray or beam so that radicals are generated. Specific examples thereof include benzoin ether derivatives, aryl alkyl ketones such as acetophenone derivatives, oxime ketones, acylphosphine oxides, S-phenylthiobenzoic acid, thitanocene, and derivatives obtained by polymerizing these compounds, respectively. However, the generator is not limited to these compounds. Examples of a commercially available product of the cleaving-type optical radical generator include 1-(4-dodecylbenzoyl)-1-hydroxy-1-methylethane, 1-(4-isopropylbenzoyl)-1-hydroxy-1-methylethane, 1-benzoyl-1-hydroxy-1-methylethane, 1-[4-(2-hydroxyethoxy)-benzoyl]-1-hydroxy-1-methylethane, 1-[4-(acryloyloxyethoxy)-benzoyl]-1-hydroxy-1-methylethane, diphenyl ketone, phenyl-1-hydroxy-cyclohexyl ketone, benzyldimethyl ketal, bis(cyclopentadienyl)-bis(2,6-difluoro-3-pyrryl-phenyl)titanium, (η6-isopropylbenzene)-(η5-cyclopentadienyl)-iron (II)hexafluorophosphate, trimethylbenzoyldiphenylphosphine oxide, bis(2,6-dimethoxy-benzoyl)-(2,4,4-trimethyl-pentyl)-phosphine oxide, bis(2,4,6-trimethylbenzoyl)-2,4-dipentoxyphenylphosphine oxide, or bis(2,4,6-trimethylbenzoyl)phenyl-phosphine oxide, (4-morpholinobenzoyl)-1-benzyl-1-dimethylaminopropane, an 4-(methylthiobenzoyl)-1-methyl-1-morpholinoethane. However, the commercially available product usable in the present invention is not limited to these examples.

Optical radical generators (B) as described above, that is, hydrogen-drawing-type and cleaving-type optical radical generators may be used alone, or in any combination of two or more thereof. From the viewpoint of the stability of the optical radical generators alone, and the curability of the composition used in the present invention, it is preferred to use two or more cleaving-type optical radical generators in combination. Among cleaving-type optical radical generators, acylphosphine oxides are preferred. More specifically, preferred is trimethylbenzoyldiphenylphosphine oxide (trade name: DAROCURE TPO, manufactured by Ciba Japan K.K.), bis(2,6-dimethoxy-benzoyl)-(2,4,4-trimethyl-pentyl)-phosphine oxide (trade name: “CGI 403”, manufactured by Ciba Japan K.K.), or bis(2,4,6-trimethylbenzoyl)-2,4-dipentoxyphenylphosphine oxide (trade name: “IRGACURE 819”, manufactured by Ciba Japan K.K.).

The content of the optical radical generator(s) (B) is preferably from 0.01 to 10 parts by mass, more preferably from 0.05 to 5 parts by mass, particularly preferably from 0.1 to 3 parts by mass for the total amount of the active-energy-ray curable adhesive.

In the case of using the active-energy-ray curable adhesive of an electron beam curable type in the present invention, the optical radical generator (B) is arbitrarily usable in the adhesive. Thereto may be added a sensitizer for raising the speed of the curing based on an electron beam, and the sensitivity to the beam. Typical example thereof include carbonyl compounds.

Other examples of the sensitizer include anthracene, anthracene derivatives, phenothiazine, perylene, thioxanthone, and benzophenonethioxanthone. Additional examples of the sensitizing dye include thiopyrylium dyes, melocyanine dyes, quinoline dyes, styrylquinoline dyes, ketocoumarin dyes, thioxanthene dyes, xanthene dyes, oxonol dyes, cyanine dyes, rohdamine dyes and pyrylium dyes.

Specific examples of effective anthracene compound include dibutoxyanthracene, and dipropoxyanthraquinone (Anthracure UVS-1331 or 1221, manufactured by Kawasaki Kasei Chemicals Ltd.).

When the sensitizer is added, the content thereof is preferably from 0.01 to 20 parts by mass, more preferably from 0.01 to 10 parts by mass, particularly preferably from 0.1 to 3 parts by mass for the total amount of the active-energy-ray curable adhesive.

Various additives may be blended as optional components into the active-energy-ray curable adhesive as far as the attainment of the objects of the present invention is not hindered. Examples of the additives include polymers and oligomers such as polyamide, polyamideimide, polyurethane, polybutadiene, polychloroprene, polyether, polyester, styrene/butadiene block copolymer, petroleum resin, xylene resin, ketone resin, cellulose resin, fluorine-contained oligomer, silicone oligomer, and polysulfide oligomer; polymerization inhibitors such as phenothiazine, and 2,6-di-t-butyl-4-methylphenol; polymerization initiator auxiliaries; leveling agents; wettability improvers; surfactants; plasticizers; ultraviolet absorbents; silane coupling agents; inorganic fillers; pigments; and dyes. The content of the additives is preferably from 0.005 to 20 parts by mass, more preferably from 0.01 to 10 parts by mass, particularly preferably from 0.1 to 5 parts by mass for the total amount of the active-energy-ray curable adhesive.

The viscosity of the active-energy-ray curable adhesive is preferably from 10 to 300 cps (at 25° C.), more preferably from 20 to 300 cps (at 25° C.), even more preferably from 40 to 150 cps (at 25° C.). If the viscosity is 10 cps or less, the viscosity is too low so that the applied adhesive may extend around to the rear side of the film (single-side protected polarizing film) or the thickness of the adhesive layer is not easily adjusted. If the viscosity is more than 300 cps, the viscosity is too high. Thus, the adhesive cannot be sufficiently applied when the line speed is raised, or apply streaks are easily generated. Thus, the high viscosity is unfavorable for the productivity of optical laminated-films.

In a case where the optical laminated-film is a polarizing film in which a polarizer and a transparent protective film are laminated onto each other through the adhesive layer, at the time of bonding the polarizer and the transparent protective film onto each other, an easily-bondable layer may be laid between the transparent protective film and the adhesive layer. The easily-bondable layer may be made of a resin. The resin may be of various types. Examples thereof include resins respectively having various skeletons, such as polyester, polyether, polycarbonate, polyurethane, polyamide, polyimide, and polyvinyl alcohol skeletons; and silicone resin. These polymer resins may be used alone or in combination of two or more thereof. Additives may be added to the easily-bondable layer. Specific examples thereof include a tackifier, an ultraviolet absorbent, an antioxidant, and stabilizers such as a heat-resistant stabilizer.

Usually, the easily-bondable layer is beforehand laid onto a transparent protective film, and a polarizer is bonded onto the easily-bondable layer side surface of the transparent protective film through the adhesive layer. The easily-bondable layer is formed by applying a forming-material of the easily-bondable layer onto the transparent protective film, and then drying the workpiece by a known technique. The forming-material of the easily-bondable layer is usually prepared in the form of a solution in which the material is diluted into an appropriate concentration, considering the post-dry thickness of the material, the smoothness of the applying, and others. The post-dry thickness of the easily-bondable layer is preferably from 0.01 to 5 μm, more preferably from 0.02 to 2 μm, even more preferably from 0.05 to 1 μm. Plural easily-bondable layers may be laid. In this case also, the total thickness of the easily-bondable layers is preferably adjusted into the above-mentioned range.

When the polarizing film is produced in a continuous line, the line speed, which depends on the curing period of the adhesive, is preferably from 1 to 500 m/min, more preferably from 5 to 300 m/min, even more preferably from 10 to 100 m/min. If the line speed is too small, the productivity is poor and further a large damage is given to the transparent protective film so that the polarizing film cannot be produced with endurance against an endurance test and others. If the lines speed is too large, the adhesive is insufficiently cured so that a target tackiness may not be gained.

As described above, a polarizing film is obtained which has a polarizer and a transparent protective film over at least one surface of the polarizer. A functional layer, such as a hard coat layer, an antireflective layer, a sticking preventing layer, a diffusion layer, or an anti-glare layer, may be laid over the surface of the transparent protective film onto which the polarizer is not bonded. The functional layer, such as a hard coat layer, an antireflective layer, a sticking preventing layer, a diffusion layer, or an anti-glare layer, may be laid onto the transparent protective film itself, or may be laid in the form of a part of a member separated from the transparent protective film.

When practically used, a polarizing film, which is a sort of optical laminated-film, may be used in the form of an optical film in which this polarizing film is laminated on any other optical layer or layers. The optical layer(s) is/are not particularly limited, and may (each) be an optical layer used to form a liquid crystal display device. The optical layer is, for example, a reflective plate, a semi-transmissible plate, a retardation plate, which may be a wavelength plate such as a half wavelength plate or quarter wavelength plate, or a viewing angle compensation film. The polarizing film is particularly preferably a reflective polarizing film or semi-transmissible polarizing film in which a reflective plate or a semi-transmissible reflective plate is laminated; an elliptically polarizing film or circularly polarizing film in which a retardation plate is further laminated on a polarizing film; a wide viewing angle polarizing film in which a viewing angle compensation film is further laminated on a polarizing film; or a brightness enhancement polarizing film in which a brightness enhancement film is further laminated on a polarizing film.

An optical film in which optical layers as described above are laminated on a polarizing film may be formed in the manner of laminating the layers independently and successively in a process for producing, for example, a liquid crystal display device. An optical film obtained, as an independent article, by laminating the layers beforehand is excellent in quality stability, fabricating workability and others to have an advantage of improving a process for producing, for example, a liquid crystal display device. For the laminating, an appropriate bonding means or member, such as an adhesive layer, is usable. When a polarizing film as described above or any other optical film is bonded, the optical axis thereof may be set to an appropriate configuration angle in accordance with a target retardation property, or others.

A polarizing film as described above, or an optical laminated-film in which such a polarizing film or polarizing films are laid may be provided with a pressure-sensitive adhesive layer in order to be bonded onto a different member such as a liquid crystal cell. An adhesive for forming the pressure-sensitive adhesive layer is not particularly limited, and may be appropriately selected, for use, from materials each containing, as a base polymer, acrylic polymer, silicone polymer, polyester, polyurethane, polyamide, polyether, fluorine-contained polymer or rubbery polymer. It is particularly preferred to use an acrylic adhesive, or any other adhesive that is excellent in optical transparency and shows appropriate pressure-sensitive adhesive properties such as appropriate wettability, cohesive property and tackiness to be excellent in weather resistance, heat resistance and others.

The pressure-sensitive adhesive layer may be laid, in the form of laminated layers different from each other in composition, kind or some other, onto one or each of the two surfaces of a polarizing film or an optical film. The pressure-sensitive adhesive layers laid on the front and rear surfaces may be pressure-sensitive adhesive layers different from each other in composition, kind, thickness or some other. The thickness of the pressure-sensitive adhesive layer(s) may be appropriately decided in accordance with a purpose of the use, the pressure-sensitive adhering power, and others. Generally, the thickness is preferably from 1 to 500 μm, preferably from 1 to 200 μm, particularly preferably from 1 to 100 μm.

The naked surface of (each of) the pressure-sensitive adhesive layer(s) is covered with a separator bonded temporarily to the surface for the prevention of contamination, and others until the film is practically used. In this way, a user can be prevented from contacting the pressure-sensitive adhesive layer(s) in such a manner that the user usually handles any article. The separator may be appropriately selected from the same separators as used in the prior art except the above-mentioned thickness requirement. The separator may be an appropriate piece, such as a plastic film, a sheet of rubber, paper, cloth, nonwoven fabric, net, a foamed sheet, a metal foil piece, or a laminate composed of such pieces. The piece may be optionally subjected to coating treatment with an appropriate release agent such as a silicone, a long-chain alkyl compound, a fluorine-contained compound, or molybdenum sulfide.

A polarizing film or optical laminated-film as described above is preferably usable to form a liquid crystal display device, or any other device. The liquid crystal display device may be formed in accordance with a conventional method. Specifically, a liquid crystal display device is generally formed by a method of fabricating appropriately constituting-members, such as a liquid crystal cell, a polarizing film or optical film, and an optical lighting system, and then integrating a driving circuit thereinto; in the present invention, a liquid crystal display device may be formed in accordance with this conventional method without any special limitation except that a polarizing film or optical laminated-film according to the present invention is used. The liquid crystal cell may be of any type, such as a TN, STN, or π type.

In the present invention, an appropriate liquid crystal display device may be formed, examples thereof include a display device in which a polarizing film or optical laminated-film is arranged on a single side or each side of a liquid crystal cell, or a display device in which a backlight or reflective plate is further used for a lighting system. In this case, a polarizing film or optical laminated-film according to the present invention may be used as the arranged polarizing film or optical laminated-film. The polarizing films or optical laminated-films arranged on both the sides of the liquid crystal cell, respectively, may be the same or different. Furthermore, when the liquid crystal display device is formed, one or more appropriate members, such as a diffusion plate, an anti-glare layer, an antireflective film, a protective plate, a prism array, a lens array sheet, a light diffusion plate or a backlight, may be arranged in the form of one or more layers at one or more appropriate positions.

### EXAMPLES

Hereinafter, the present invention will be specifically described by way of working examples. However, the present invention is not limited by these examples. In each of the examples, the word “part(s)” and the symbol “%” both denote “part(s) by weight”.

### <Production of Each Polarizing Film>

In order to produce each thin polarizing film, a laminate was first prepared in which a 9 μm thick PVA layer was formed on an amorphous PET substrate. This laminate was subjected to subsidiary drawing at a drawing temperature of 130° C. in the air to produce a drawn laminate. Next, the draw laminate was dyed to produce a colored laminate. Furthermore, the colored laminate was subjected to drawing in an aqueous boric acid solution at a drawing temperature of 65° C. into a total draw ratio of 5.9 to produce an optical film laminate containing a 4 μm thick drawn PVA layer unified with the (drawn) amorphous PET substrate. By this two-stage drawing, PVA molecules in the PVA layer formed on the amorphous PET substrate were highly aligned. By dyeing, iodide was adsorbed thereinto so that iodine was highly aligned, in the form of a polyiodine ion complex, into one direction in the resultant. In this way, a highly functional polarizing film was able to be produced which was an optical film laminate containing the 4 μm thick PVA layer. This PVA layer (thin polarizer) had a moisture content of 1.7% within one hour of the time after dried.

The optical film laminate containing the 4 μm thick PVA layer, and a film having a thickness of 60 μm (ZEONOR FILM, manufactured by Zeon Corp.) as a compensation plate were bonded to each other through an adhesive layer obtained by curing an active-energy-ray curable adhesive composition (composed of the following: hydroxyethylacrylamide (HEAA): 50 parts; acryloylmorpholine (ACMO): 40 parts; NEW FRONTIER PGA: 10 parts; IRGACURE 907 as a polymerization initiator: 2 parts; and diethylthioxanthone (DETX) as a photosensitizer: 0.9 part). Thereafter, the amorphous PET substrate was peeled to produce an optical laminated-film in which a thin polarizer was laminated on the compensation plate.

### Example 1

One of the produced optical films was used as the optical film 3, wherein the thin polarizer was laminated to be located on the front surface side of the optical film 3 (i.e., the compensation plate was laminated to be located on the earth-roll-1-contacting side of the optical film 3). The device illustrated in FIG. 1 was used to conduct corona discharge treatment onto the optical film 3 using the treatment electrode 4 while the optical film 3 was brought into contact with the outer circumferential surface of the earth roll 1 and simultaneously fed. The earth roll 1 was cooled to adjust the surface temperature thereof to 25° C., and the electric discharge quantity was 250 W·min/m² in the corona discharge treatment.

### Examples 2 to 5

In each of these examples, an activating treatment was conducted in the same way as in Example 1 except that the electric discharge quantity in the corona discharge treatment was changed in a quantity shown in Table 1.

### Example 6

An activating treatment was conducted in the same way as in Example 1 except that the corona discharge treatment was changed to atmospheric pressure plasma treatment (electric discharge quantity: 250 W·min/m²).

### Comparative Example 1

An activating treatment was conducted in the same way as in Example 1 except that when the corona discharge was conducted, the earth roll 1 was not cooled.

Measurements were made by methods described below about the external appearance of the front surface of the optical laminated-film subjected to the activating treatment by the activating treatment method in each of Examples 1 to 6 and Comparative Example 1, and the tackiness of the optical laminated-film. The results are shown in Table 1.

### <Method for Evaluating External Appearance>

The front surface of the optical laminated-film subjected to the activating treatment in each of Examples 1 to 6 and Comparative Example 1 was observed with the naked eye. When only one defect was found per m² of the front surface, the optical laminated-film was judged to be poor (x) in external appearance. The results are shown in Table 1.

### <Method for Evaluating Tackiness>

The optical laminated-film was subjected to forcible peeling treatment. When no peel was generated between the adhesive and the optical film, the optical laminated-film was judged to be good (◯) in tackiness. When a peel was generated between the adhesive and the optical film, the optical laminated-film was judged to be poor (x).

TABLE 1

| | | | | Electric | | |
|---|---|---|---|---|---|---|
| | Kind of | | | discharge | | |
| | electric | Optical | Earth | quantity | | External |
| | discharge | film | roll | [W · min/m²] | Tackiness | Appearance |
| Example 1 | Corona | Polarizer | Cooled | 250 | ◯ | ◯ |
| Example 2 | Corona | Polarizer | Cooled | 100 | ◯ | ◯ |
| Example 3 | Corona | Polarizer | Cooled | 400 | ◯ | ◯ |
| Example 4 | Corona | Polarizer | Cooled | 2000 | ◯ | ◯ |
| Example 5 | Corona | ZEONOR | Cooled | 100 | ◯ | ◯ |
| Example 6 | Plasma | Polarizer | Cooled | 250 | ◯ | ◯ |
| Comparative | Corona | Polarizer | Not | 100 | ◯ | X |
| Example 1 | | | cooled | | | |

From the results in Table 1, it is understood that about the optical laminated-film subjected to the activating treatment method according to each of Examples 1 to 6, the tackiness was good and further external appearance defects were hardly generated so that the property of the external appearance was good. However, about the optical laminated-film subjected to the activating treatment method according to Comparative Example 1, many external appearance defects were generated so that the property of the external appearance was deteriorated.
1: earth roll
21, 22: guide roll
4: treatment electrode
5: external atmosphere
6: electrode roll

What is claimed is:

1. An activating treatment method for an optical film, comprising feeding the optical film along a roll, and subjecting the optical film to the activating treatment from a side of the optical film that is opposite to a side of the optical film at which the roll is located,
wherein the activating treatment is conducted while the roll is cooled.

2. The activating treatment method according to claim 1, wherein the activating treatment is at least one of corona discharge treatment, plasma treatment, and glow discharge treatment.

3. The activating treatment method according to claim 1, wherein the optical film is at least one of a polarizer and a transparent protective film.

4. The activating treatment method according to claim 2, wherein in the activating treatment, an electric discharge quantity of 100 to 2000 W·min/m² is discharged.

5. The activating treatment method according to claim 1, wherein the roll is cooled by passing a coolant into the roll.

6. A method for producing an optical laminated-film comprising a first optical film, an adhesive layer and a second optical film in which the second optical film is laminated over at least one surface of the first optical film to interpose the adhesive layer between the optical films,
comprising an activating treatment step of conducting the activating treatment method recited in claim 1 onto a surface of the first optical film onto which the adhesive layer is to be laminated,
an applying step of applying an adhesive onto the surface of the first optical film onto which the activating treatment is conducted, thereby laminating a layer of the adhesive onto the surface, and
a laminating step of bonding the first optical film on which the adhesive layer is laminated over the second optical film through the adhesive layer.

7. The method for producing the optical laminated-film according to claim 6, wherein: the optical laminated-film is a polarizing film comprising a polarizer, an adhesive layer and a transparent protective film in which the transparent protective film is laminated over at least one surface of the polarizer to interpose the adhesive layer between the polarizer and the film;
the method comprising: the activating treatment step which is an activating treatment step of conducting the activating treatment method onto at least one of the polarizer and the transparent protective film; the applying step which is an applying step of applying the adhesive onto the surface of the polarizer that is subjected to the activating treatment or the surface of the transparent protective film that is subjected to the activating treatment, thereby laminating a layer of the adhesive onto the surface; and the laminating step which is a laminating step of bonding the polarizer and the transparent protective film over each other through the adhesive layer.

8. An optical laminated-film obtained by the producing method recited in claim 6.

9. An image forming device, using the optical laminated-film recited in claim 8.
